(19) United States
(12) Patent Application Publication
(10) Pub. No.: US 2011/0235997 A1
(43) Pub. Date: Sep. 29, 2011

(54) METHOD AND DEVICE FOR CREATING A MODIFIED VIDEO FROM AN INPUT VIDEO

(75) Inventor: Declan Patrick Kelly, Shanghai (CN)

(73) Assignee: KONINKLIJKE PHILIPS ELECTRONICS N.V., EINDHOVEN (NL)

(21) Appl. No.: 12/671,740

(22) PCT Filed: Aug. 5, 2008
(86) PCT No.: PCT/IB2008/053119

§ 371 Date: Feb. 2, 2010

(30) Foreign Application Priority Data
Aug. 9, 2007 (CN) 200710140722.7

(51) Int. Cl. H04N 5/93

(52) U.S. Cl. 386/280; 386/278; 386/E05.003

(57) ABSTRACT

The present invention provides a method of and a device for creating a modified video from an input video, the method comprising the steps of: generating at least one sub-video corresponding to a sub-view of the input video; and integrating the generated sub-video into the original input video along the time axis for creating a modified video, the modified video therefore including some close-ups content coming from the input video, the modified video being more attractive than the original input video.

### FIELD OF THE INVENTION

The present invention relates to a method of and a device for creating a modified video from an input video, for example, for editing an input video captured by a camcorder.

### BACKGROUND OF THE INVENTION

Video contents created by means of a video recorder, such as a camcorder, generally have a lower quality than professional video contents. Even after advanced user-editing of the raw camcorder footage, the resulting quality is still not satisfactory to users who are used to watch professionally edited content.

One reason why video content generated by a camcorder looks worse than professional content is that a video scene is shot by a single camera, e.g. at a single recording angle. In the case of professional content, however, multiple-angle cameras are used, which allows switching the angles within a scene, for example from wide angle shots to close-ups.

Currently, although some video editing software is provided to users for video editing, such software requires specialized skills, making it difficult to use and also time-consuming.

### OBJECT AND SUMMARY OF THE INVENTION

It is an object of the invention to provide a method of creating a modified video from an input video.

To this end, the method according to the present invention comprises the following steps: generating at least one sub-video corresponding to a sub-view of the input video; and integrating the generated sub-video into the input video along the time axis for creating the modified video.

The modified video may include some close-up content coming from the input video, as a result of which the modified video is more attractive than the original input video.

Advantageously, the step of generating further comprises a step of identifying a sub-view, and a step of extracting sub-views from the original input video.

Advantageously, the step of integrating comprises a step of replacing a clip of the input video by a generated sub-video.

Advantageously, the integrating step comprises a step of inserting the generated sub-video into the input video.

It is also an object of the invention to provide a device for creating a modified video from an input video.

To this end, the device according to the invention comprises a first module for generating at least one sub-video corresponding to a sub-view of said input video; and a second module for integrating said sub-video into said input video along the time axis for creating said modified video.

It is also an object of the invention to provide a video recorder comprising a device as described above, for creating a modified video from an input video.

Detailed explanations and other aspects of the invention will be given below.

### BRIEF DESCRIPTION OF THE DRAWINGS

Particular aspects of the invention will now be explained with reference to the embodiments described hereinafter and considered in connection with the accompanying drawings, in which identical parts or sub-steps are designated in the same manner:

FIG. 1 depicts a flow chart of the method of creating a modified video from an input video according to the invention;

FIG. 2 depicts an example of identifying sub-views from an input video according to the present invention;

FIG. 3 depicts an example of extracting sub-views from an input video according to the present invention;

FIG. 4, FIG. 5, and FIG. 6 depict examples of modified videos along the time axis according to the present invention;

FIG. 7 depicts an example of extracting a set of sub-views with gradually changing size according to the present invention;

FIG. 8 depicts an example of moving sub-views across the screen according to the present invention;

FIG. 9 depicts an example of a graphical user interface used in the present invention;

FIG. 10 depicts a block diagram showing functional modules for creating a modified video from an input video according to the present invention;

FIG. 11 schematically depicts an apparatus for creating a modified video from an input video according to an embodiment of the present invention.

### DETAILED DESCRIPTION OF THE INVENTION

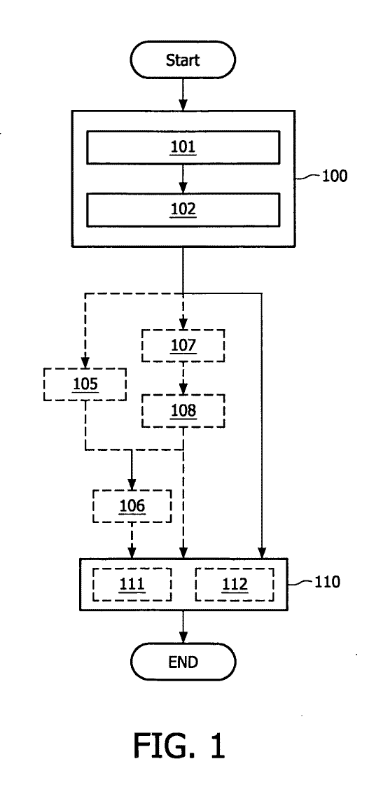

FIG. 1 shows a first flow chart of the method of creating a modified video from an input video according to the invention.

The method comprises a step of generating 100 at least one sub-video corresponding to a sub-view of the input video, followed by a step of integrating 110 the generated sub-video into the input video along the time axis for creating a modified video.

The input video can be any video format, for example, MPEG-2, MPEG-4, DV, MPG, DAT, AVI, DVD or MOV. The input video can be captured by a video camera, for example a camcorder or the like.

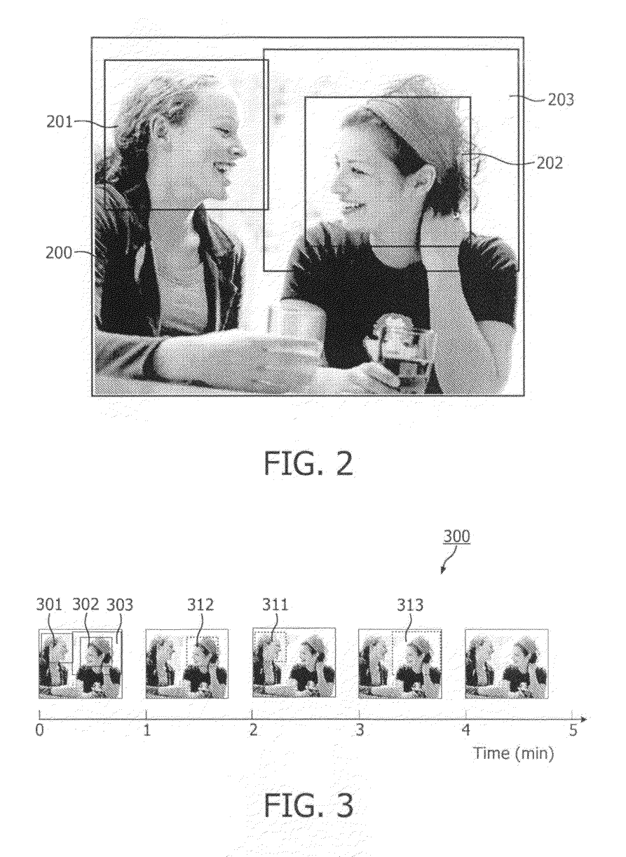

According to the invention, a sub-view is a partial view of the image in the input video. For example, FIG. 2 shows an input video 200 depicting a scene having a first person (face 1) on the left and a second person (face 2) on the right, 201 is a first sub-view including face 1; 202 is a second sub-view including face 2; 203 is another example of a sub-view which also includes face 2 but with a larger background than sub-view 202.

According to the invention, a sub-video consists of frames including data of sub-views belonging to successive frames of the input video, and is generated by the generating step 100. For example, FIG. 3 depicts a scene of an input video 300 having a first person on the left and a second on the right (either talking or listening) along the time axis. A sub-video 311 (surrounded by broken lines) consisting of frames including sub-views 301 is generated by the generating step 100. In the same way, a sub-video 312 corresponding to sub-view 302, and a sub-video 313 corresponding to sub-view 303 can also be generated.

It is noted that in the following drawings, only one picture per different video scene is shown, to facilitate the illustration.

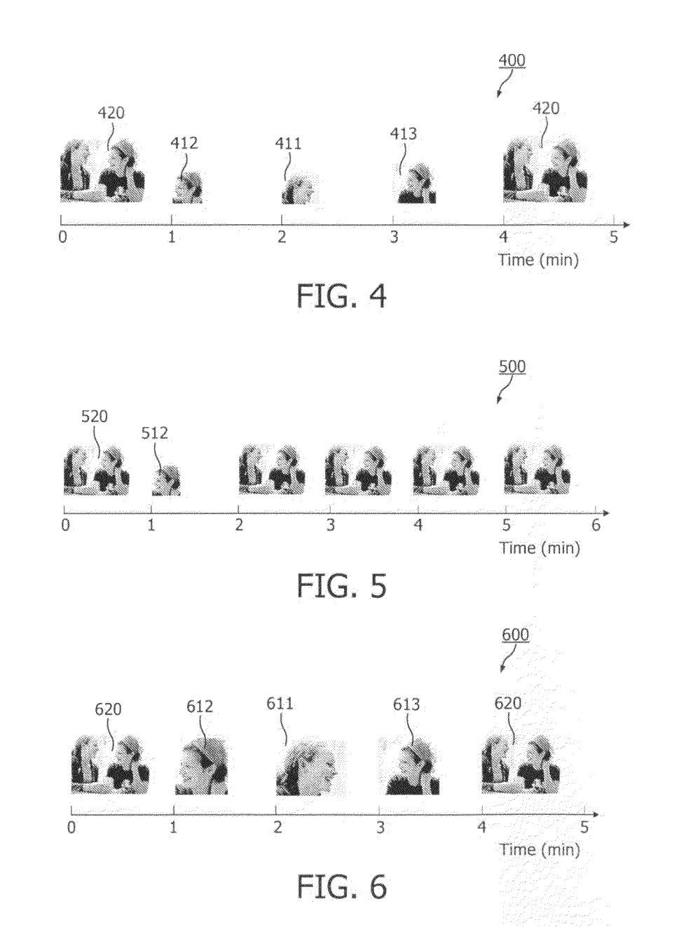

Step 110 is used for integrating a sub-video into the input video. FIG. 4 shows, along the time axis, a modified video 400 consisting of an input video 420 and the sub-videos 412, 411, 413. In other words, in the modified video 400, during the first minute, the first minute of the clip belonging to input video 420 will be played; during the second minute, the sub-video 412 will be played; during the third minute, the sub-video 411 will be played; during the fourth minute, the sub-video 413 will be played; and during the fifth minute, the fifth minute of the clip belonging to input video 420 will be played. In such a way, by assembling sub-videos and clips of the input video along the time axis, the modified video 400 is created.

It is to be understood by the person skilled in the art, that the step of integrating 110 could be implemented by various methods according to the data content of the input video, as will be explained in detail herein below.

Alternatively, as depicted by the flow chart of FIG. 1, the step 100 further comprises a step 101 of identifying a sub-view.

In order to identify a sub-view in a video, some preferences need to be given. For example, the amount of desired sub-views, the size of desired sub-views, and the shape of desired sub-views need to be given.

As illustrated by FIG. 2, a given preference should be: if the sub-view relates to the content of talking, then two different sizes of sub-views including the face of the person who is speaking, and a third one including the face of the person who is listening should be identified. Therefore, a sub-view 202 and a sub-view 203 are identified as the close-ups of the person speaking, and a sub-view 201 is identified as the close-up of the person listening.

Advantageously, the step of identifying 101 further comprises a step of detecting an object from the input video to identify a sub-view according to the detected object.

For example, by detecting the data content of the input video, a face, a moving object or a central object could be detected as an object. As illustrated by FIG. 2, face 1 on the left of the picture and face 2 on the right of the picture can be detected as objects. Based on the result of the detection and the predefined preferences, sub-views 201, 202, 203 including the detected objects (face 1, and face 2) are identified as discussed in the above identifying step 101.

Alternatively, the step of identifying 101 further comprises a step of receiving a user input for a user to identify a sub-view.

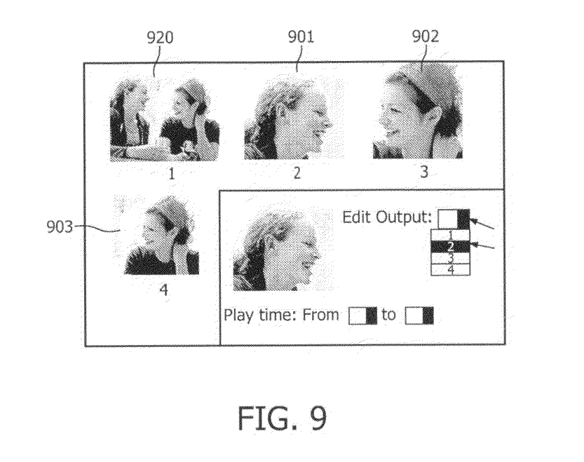

FIG. 9 shows an example of a graphical user interface which displays all the identified sub-views 901, 902, 903 and one picture 920 of the input video to the user. The user has the possibility to choose sub-views to be used for creating a modified video. In this example, sub-view 901 is selected by the user.

The sub-views can also be identified completely by a user input through the user interface. In this case, the user will select the object to be contained in the sub-view and determine the above mentioned preferences.

As shown in the flow chart of FIG. 1, the step 100 further comprises a step of extracting 102 the identified sub-view from the input video. A set of frames including data of sub-views will be extracted from the input video for generating the corresponding sub-video.

For example, FIG. 3 shows a 5 minute input video 300 along the time axis. If this input video comprises 25 frames per second, then the second minute comprises 1500 frames. The data for generating the sub-video 312 corresponding to the sub-view 302 is extracted from these 1500 frames. Similarly, a sub-video 311 corresponding to the sub-view 301 is generated from the third minute of the input video, and a sub-video 313 corresponding to the sub-view 303 is generated from the fourth minute of the input video.

The extracting step 102 may contain predefined criteria to instruct how and where to extract the sub-views.

For example, in FIG. 3, the criteria can be to extract the data of sub-views during the time when the relevant person is speaking. For example, if person 1 on the left of the picture is speaking during the third minute, the related sub-views 301 will be extracted successively during the third minute of the input video.

In another example, the extracting criteria can be to extract the data of sub-views by tracking the detected object so that the object is always in the sub-views, no matter whether the object is moving or not.

In another example, the extracting criteria allow to extract a set of sub-views by gradually varying the background size.

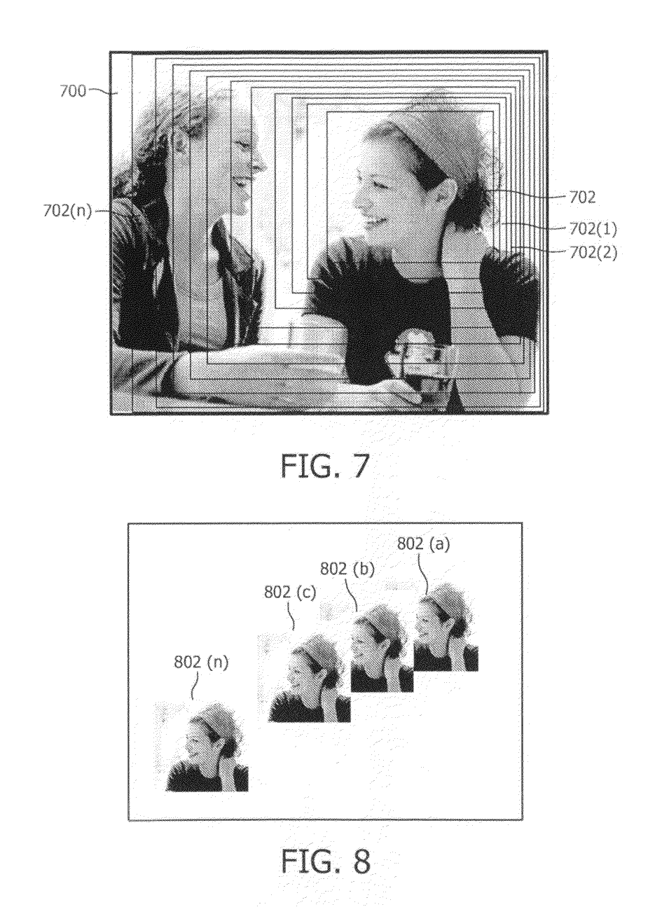

For example, FIG. 7 shows a set of sub-views with various sizes. A set of sub-views (702(1), 702(2), 702(n)) with gradually increasing sizes is extracted from the input video 700. Therefore, a sub-video will be generated based on these sub-views having gradually increasing sizes. When playing the corresponding sub-video, a zooming effect will be created between the sub-view 702 and the complete view.

Alternatively, as illustrated in FIG. 1, the step of integrating 110 comprises a step of replacing 111 a clip of the input video by the generated sub-video. The clip of the input video to be replaced may have the same time length as the generated sub-video. In other words, frames of the generated sub-video are used for replacing the frames of the input video having the same time length. The replaced frames can be the frames used for generating the sub-video.

For example, as illustrated in FIG. 4, the modified video 400 is made up of the original input video 420, with the clip of the second minute being replaced by the sub-video 412 and the clip of the third minute being replaced by the sub-video 411 and the clip of the fourth minute being replaced by sub-video 413, wherein data of sub-video 412 is extracted from the second minute of the input video 420, and data of sub-video 411 is extracted from the third minute of the input video 420, and similarly, data of sub-video 413 is extracted from the fourth minute of the input video 420.

Alternatively, the clip of the input video to be replaced may also have the different time length as the generated sub-video, i.e. the frame amount of the input video clip is different with the frame amount of the generated sub-video.

Alternatively, in the replacing step 111, the sub-video can also be used to replace any other clip which does not provide the data of the sub-video with the same time length. In this case, the audio associated with the video should be taken into account, because the corresponding audio will also be replaced when the frames are replaced. In order to avoid the audio being disordered, the complete original audio can be removed or replaced with music during editing.

Alternatively, as illustrated in FIG. 1, the integrating step 110 further comprises a step of inserting 112 a sub-video into the input video along the time axis. In this case, the total duration of the input video is changed.

For example, FIG. 5 depicts an example of a modified video 500 along the time axis according to the present invention. The sub-video 512 is inserted into the input video 520 along the time axis. As a result, the total time length of the modified video 500 is increased from 5 minutes to 6 minutes. Similarly, when the sub-video 512 is inserted, the corresponding audio will also be inserted. In this case, the original audio can be replaced with music during editing. Therefore, there will be no repetition of audio when the sub video is inserted.

Alternatively, as depicted in FIG. 1, the method according to the invention further comprises a step of enlarging 107 the display size of the generated sub-video. For example, a sub-video is enlarged to the full screen size of the original input video.

For example, FIG. 6 shows a modified video 600 along the time axis, wherein the display size of sub-video 611, 612 and 613 is enlarged.

Alternatively, the step of enlarging 107 further comprises a step of enhancing 108 the resolution of the enlarged sub-video.

One way of enhancing the resolution is, for example, up-scaling, which means that pixels are artificially added. For example: upscaling SD (standard density) (576*480 pixels) to HD (high density) (1920*1080 pixels) could be done by this step of enhancing 108 the resolution.

Alternatively, the method according to the invention further comprises a step of gradually moving 105 the position of said extracted sub-views along the time axis. This step allows the creation of a panning effect in the modified video.

FIG. 8 shows an example of moving the position of the extracted sub-views 802(a), 802(b), 802(c) . . . and 802(n) successively. When playing the sub-video composed of frames of sub-views (802(a), 802(b), 802(c) . . . 802(n)) located in different positions on the screen, the panning effect will be created.

Alternatively, the method according to the invention further comprises a step of gradually fading in or fading out 106 the sub-video. Fading in here means causing the image or sound to appear or be heard gradually. Fading out here means causing the image or sound to disappear gradually.

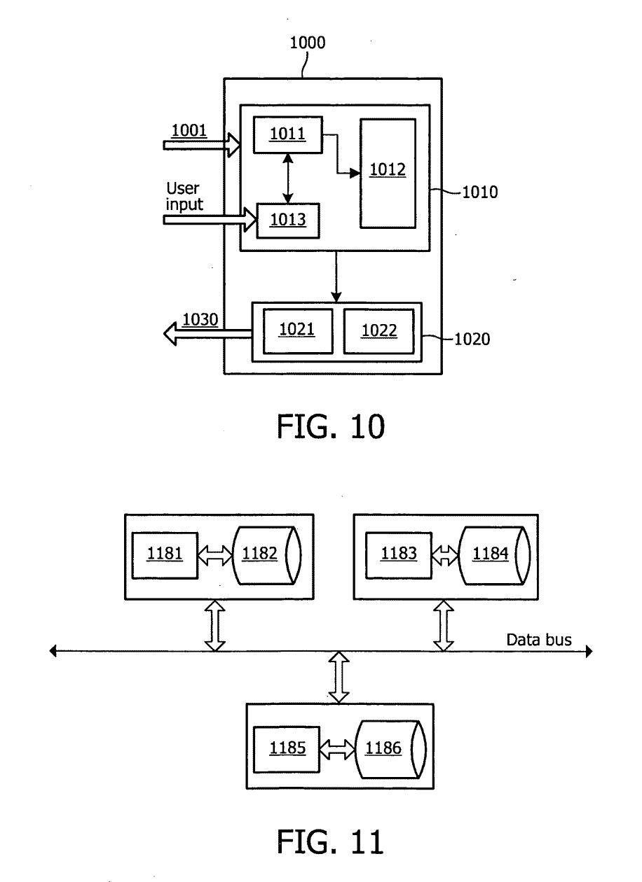

FIG. 10 depicts the functional modules of a device 1000 according to the invention, for creating a modified video 1030 from an input video 1001. The functional modules of device 1000 are intended to perform functionalities of the steps of the method according to the invention described above.

The video modification device 1000 comprises a first module 1010 for generating at least one sub-video corresponding to a sub-view of the input video, and a second module 1020 for integrating the generated sub-video into the original input video along the time axis for creating a modified video.

The first module 1010 further comprises a first unit 1011 for identifying a sub-view from the data content of the original input video, and a second unit 1012 for extracting the identified sub-view from the original input video.

The first unit 1011 is used for identifying the sub-view according to predefined preferences and a given object. To detect an object, some kind of object detection unit can be used, such as: a face detection unit, a moving object detection unit, a center object detection unit, etc. After detecting an object, the system identifies a sub-view including the detected object according to the predefined preferences, as previously described, according to the method of the invention.

The second unit 1012 is used for extracting sub-views from the original input video, similarly to step 102 described above.

The second module 1020 is used for integrating a sub-video into an original input video for creating a modified video.

Alternatively, the second module 1020 further comprises a third unit 1021 for replacing clips of the input video by the generated sub-video, similarly to step 111 described above, according to the method of the invention.

Alternatively, the second module 1020 further comprises a fourth unit 1022 for inserting the generated sub-video into original input video, similarly as step 112 described according to the method of the invention.

Alternatively, the first module 1010 further comprises a fifth unit 1013 to receive a user input for a user to identify a sub-view. The receiving unit 1013 receives user input via a user interface. The user can either choose the sub-views provided by the system or select an object and identify the corresponding sub-views directly, similarly to the step of receiving a user input described above according to the method of the invention.

FIG. 11 shows an example of an implementation of a device for creating a modified video from an input video according to the invention.

This implementation comprises:
a first processor 1181 for identifying a sub-view including a given object of the original input video; and
a first memory 1182, connected to said first processor 1181, for storing the identified sub-view and the related code instructions.

This implementation also comprises:
a second processor 1183 for extracting the sub-views from an original input video; and
a second memory 1184, connected to said first processor 1183, for storing the extracted sub-view data and the related code instructions.

This implementation also comprises:
a third processor 1185 for integrating the original input video; and
a third memory 1186, connected to said first processor 1185, for storing the original input video, the generated sub-video, the modified video and related code instructions.

Memories 1182-1184-1186 and processors 1181-1183-1185 advantageously communicate via a data bus.

It is to be understood by the person skilled in the art that memories 1182, 1184, and 1186 could be combined into one memory, and that processors 1181, 1183, 1185 could be combined into a single processor.

It is also to be understood by the person skilled in the art that this invention could be implemented either by hardware or software or a combination thereof.

The present invention also relates to a video recorder for recording an input video, and comprising a device 1000 for creating a modified video from the input video. The video recorder, for example, corresponds to a camcorder or the like.

While the invention has been illustrated and described in detail in the drawings and foregoing description, illustration and description are to be considered illustrative or exemplary and not restrictive; the invention is not limited to the disclosed embodiments.

Any reference sign in a claim should not be construed as limiting the claim. The word “comprising” does not exclude the presence of elements other than those listed in a claim. The word “a” or “an” preceding an element does not exclude the presence of a plurality of such elements.

1. A method of creating a modified video (400,500,600) from an input video (420,520,620), the method comprising the steps of:
Generating (100) at least one sub-video corresponding to a sub-view of said input video;
Integrating (110) said sub-video into said input video along the time axis for creating said modified video.

2. A method as claimed in claim 1, wherein said step of generating (100) further comprises a step of identifying (101) a sub-view; and a step of extracting (102) said sub-view from said input video.

3. A method as claimed in claim 2, wherein said step of identifying (101) further comprises a step of detecting an object from said input video to identify a sub-view according to the detected object.

4. A method as claimed in claim 2, wherein said step of identifying (101) further comprises a step of receiving a user input for identifying a sub-view.

5. A method as claimed in claim 2, wherein said step of extracting allows to extract a set of sub-views by gradually varying the background size.

6. A method as claimed in claim 1, wherein said step of integrating (110) comprises a step of replacing (111) a clip of the input video by said generated sub-video.

7. A method as claimed in claim 1, wherein said step of integrating (110) comprises a step of inserting (112) said sub-video into said input video.

8. A method as claimed in claim 1, further comprising a step of enlarging (107) the display size of said sub-video.

9. A method as claimed in claim 8, wherein said step of enlarging further comprises a step of enhancing (108) the resolution of the enlarged sub-video.

10. A method as claimed in claim 2, further comprising a step of gradually moving (105) the position of said extracted sub-view along the time axis.

11. A method as claimed in claim 1, further comprising a step of fading in or fading out (106) said sub-video.

12. A device for creating a modified video (400,500,600) from an input video (420,520,620), said device comprising:
a first module (1010) for generating at least one sub-video corresponding to a sub-view of said input video;
a second module (1020) for integrating said sub-video into said input video along the time axis for creating said modified video.

13. A device as claimed in claim 12, wherein said first module (1010) comprises a first unit (1011) for identifying a sub-view from said input video, and a second unit (1012) for extracting said sub-view from said input video.

14. A device as claimed in claim 12, wherein said second module (1020) comprises a third unit (1021) for replacing frames of the input video by said generated sub-video.

15. A device as claimed in claim 12, wherein said second module (1020) comprises a fourth unit (1022) for inserting said sub-video into said input video.

16. A device as claimed in claim 12, wherein said first module (1010) further comprises a fifth unit (1013) to receive a user input for identifying a sub-view.

17. A camcorder for recording an input video (420,520,620), said camcorder comprising a device as claimed in claim 12 for creating a modified video (400,500,600) from said input video (420,520,620).
